(19) United States
(12) Patent Application Publication
(10) Pub. No.: US 2017/0158795 A1
(43) Pub. Date: Jun. 8, 2017

(54) OIL SEAL RUBBER COMPOSITION HAVING IMPROVED FREEZING RESISTANCE AND METHOD OF PREPARING THE OIL SEAL RUBBER COMPOSITION

(71) Applicants: HYUNDAI MOTOR COMPANY, Seoul (KR); KIA MOTORS CORPORATION, Seoul (KR)

(72) Inventors: Jong Min PARK, Incheon (KR); Jae Wook KANG, Hwaseong-si (KR); Kyung Mo YANG, Suwon-si (KR); Dong Gug KANG, Daegu (KR)

(21) Appl. No.: 15/094,778

(22) Filed: Apr. 8, 2016

(30) Foreign Application Priority Data
Dec. 3, 2015 (KR) 10-2015-0171706

(51) Int. Cl. C08F 236/12; C08K 3/06; C08K 5/18; C08K 3/22; C08K 5/09; C08K 5/378; C08K 3/04; C08K 5/47

(52) U.S. Cl. CPC C08F 236/12; C08K 3/04; C08K 3/06; C08K 5/47; C08K 3/22; C08K 5/09; C08K 5/378; C08K 5/18

(57) ABSTRACT

An oil seal rubber composition having improved freezing resistance includes a hydrogenated nitrile butadiene rubber (HNBR) including acrylonitrile in a content of 5 to 20 mole %, wherein a hydrogen saturation of the HNBR is 80 to 90%.

### CROSS-REFERENCE TO RELATED APPLICATION

This application claims under 35 U.S.C. §119(a) the benefit of priority to Korean Patent Application No. 10-2015-0171706, filed on Dec. 3, 2015 with the Korean Intellectual Property Office, the entire contents of which are incorporated herein by reference.

### TECHNICAL FIELD

The present disclosure relates to an oil seal rubber composition having improved freezing resistance and a method of preparing the same. More particularly, the present disclosure relates to improving freezing resistance of an oil seal rubber composition including a hydrogenated nitrile butadiene rubber (HNBR) by adjusting physical properties of the hydrogenated nitrile butadiene rubber.

### BACKGROUND

An oil seal is a sealing part that prevents oil such as a lubricant and a hydraulic fluid, a coolant, grease, or the like from leaking from various kinds of mechanical devices.

The oil seal is mainly applied to the mechanical devices in conjunction with a rotation shaft. Therefore, a rubber composition of the oil seal should have good heat resistance, oil resistance and wear resistance properties.

As problems such as oils leakages and damage to the oil seal occur in cold areas, a demand for a rubber composition having good freezing resistance is strong.

Accordingly, Korean Patent Application Laid-Open No. 10-2008-0100424 (hereinafter, referred to as ‘patent document’) discloses a composition having excellent freezing resistance formed by adjusting an acrylonitrile content and an iodine value of hydrogenated NBR.

However, a low temperature property (TR-10) of the composition of the aforementioned patent document is about −29 to −34° C., and thus freezing resistance does not reach a satisfactory level. Since a sealing function may not be adequately performed at an ultra-low temperature (−40° C. or less), a risk of oil leakage is not completely solved.

The above information disclosed in this Background section is only for enhancement of understanding of the background of the disclosure and therefore it may contain information that does not form the prior art that is already known in this country to a person of ordinary skill in the art.

### SUMMARY OF THE DISCLOSURE

The present disclosure has been made in an effort to solve the above-described problems associated with the prior art.

The present disclosure has been made in an effort to provide an oil seal rubber composition having improved sealing performance at a low temperature while maintaining heat resistance and oil resistance.

The present disclosure has also been made in an effort to provide an oil seal rubber composition having physical properties, such as hardness, tensile strength, and elongation, which are the same as or higher than those of a rubber composition of the related art, and having excellent heat resistance at a high temperature and excellent freezing resistance at a low temperature.

The present disclosure has also been made in an effort to provide an oil seal rubber composition in which a glass transition temperature is low and thus elasticity is maintained at −45° C. or less.

The object of the present disclosure is not limited to the aforementioned objects. The object of the present disclosure will be more clear by the following description, and realized by means and a combination thereof described in the claims.

In one aspect, the present disclosure provides an oil seal rubber composition having improved freezing resistance, including: a hydrogenated nitrile butadiene rubber (HNBR) including acrylonitrile in a content of 5 to 20 mole %, in which a hydrogen saturation of the HNBR may be 80 to 90%.

In a preferred embodiment, the HNBR may include acrylonitrile in a content of 15 mole % and have the hydrogen saturation of 88%.

In another preferred embodiment, the oil seal rubber composition having improved freezing resistance according to the present disclosure may further include, based on 100 parts by weight of the HNBR, 35 to 45 parts by weight of a carbon black, to 2 parts by weight of sulfur, 1 to 2 parts by weight of N-cyclehexylbenzothiozole-2-sulfenamide (CZ), 1 to 6 parts by weight of one or more selected from the group consisting of zinc oxide and a stearic acid, and 1 to 2 parts by weight of one or more selected from the group consisting of N-phenyl-N′-isopropyl-p-phenyldiamine (3C) and 2-macratobenzylimide (2-mcraptobenzimidazole, MB).

In another aspect, the present disclosure provides a method of preparing an oil seal rubber composition having improved freezing resistance, including: mixing 100 parts by weight of a hydrogenated nitrile butadiene rubber (HNBR) including acrylonitrile in a content of 5 to 20 mole % and having a hydrogen saturation of 80 to 90%, 35 to 45 parts by weight of a carbon black, 1 to 2 parts by weight of sulfur, 1 to 2 parts by weight of N-cyclehexylbenzothiozole-2-sulfenamide (CZ), 1 to 6 parts by weight of one or more selected from the group consisting of zinc oxide and a stearic acid, and 1 to 2 parts by weight of one or more selected from the group consisting of N-phenyl-N′-isopropyl-p-phenyldiamine (3C) and 2-macratobenzylimide (2-mcraptobenzimidazole, MB).

In a preferred embodiment, the HNBR may be obtained by agitating and copolymerizing acrylonitrile and butadiene at 40 to 60° C. and a rate of 40 to 60 RPM.

In another preferred embodiment, the HNBR may be prepared by hydrogenating a nitrile butadiene rubber (NBR) under the presence of a palladium catalyst.

The present disclosure includes the aforementioned constitution and thus has the following effects.

The oil seal rubber composition according to the present disclosure is effective for solving problems such as oil leakage and damage to the oil seal, which occur in northern areas such as Russia and North America since freezing resistance is excellent.

The oil seal rubber composition according to the present disclosure is effective for maintaining basic performance of the oil seal under a bitter cold condition t since a low glass transition temperature enables elasticity to be maintained at −45° C. or less.

The effect of the present disclosure is not limited to the aforementioned effects. It should be understood that the effect of the present disclosure includes all effects which can be inferred from the following description.

Other aspects and preferred embodiments of the disclosure are discussed infra.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the disclosure are discussed infra.

### DETAILED DESCRIPTION

Hereinafter reference will now be made in detail to various embodiments of the present disclosure. While the disclosure will be described in conjunction with exemplary embodiments, it will be understood that present description is not intended to limit the disclosure to those exemplary embodiments. On the contrary, the disclosure is intended to cover not only the exemplary embodiments, but also various alternatives, modifications, equivalents and other embodiments, which may be included within the spirit and scope of the disclosure as defined by the appended claims.

The descriptions of publicly known constitutions or functions thereof may be omitted if it is judged that they make the gist of the present disclosure unclear. In the specification, unless explicitly described to the contrary, the word “comprise” and variations such as “comprises” or “comprising”, will be understood to imply the inclusion of stated elements but not the exclusion of any other elements.

An oil seal is a sealing rubber used in a mechanical device such as a power steering system, an engine cylinder block, a front cover gasket, a coolant controller, and an air conditioner.

The oil seal mainly prevents leakage of a hydraulic fluid, a coolant, a grease, or the like from a gap between a rotation shaft and a periphery portion thereof.

An example thereof may include the oil seal of the power steering system. The power steering system is a device that changes a rotation motion to a rectilinear motion by hydraulic pressure force when a driver rotates a steering wheel. The oil seal of the power steering system is installed in a steering gear controlling steering strength according to the driver depending on driving conditions and changing a motion direction to transfer the motion, and thus performs sealing so as to prevent the hydraulic fluid from being leaked to the outside of a cylinder tube in the steering gear.

Since the oil seal should be continuously in contact with the hydraulic fluid, the oil seal needs to have good oil resistance. Furthermore, since the oil seal needs to endure heat, pressure, and the like resulting from a motion of the rotation shaft, heat resistance and wear resistance are also important.

Recently, as problems of oil leakage and damage to the oil seal exist in cold areas, freezing resistance has been regarded as an important physical property.

Elasticity, which the rubber may inherently have, may be lost since phase variation occurs at a glass transition temperature or less, and thus sealing performance may be reduced, or damage may occur by a load. That is, freezing resistance of the oil seal may be evaluated by the glass transition temperature.

In the related art, in order to reduce the glass transition temperature of the oil seal rubber composition, i) a plasticizer is added to a hydrogenated nitrile butadiene rubber (hereinafter, referred to as ‘HNBR’), or ii) a nitrile butadiene rubber (hereinafter, referred to as ‘NBR’) having a low glass transition temperature is used.

However, if the plasticizer is added to the rubber material, the glass transition temperature may be reduced, but heat resistance and oil resistance become poor. This is because the plasticizer may forcibly enlarge molecular chains of the rubber material to reduce bonding energy.

Compared to HNBR, heat resistance of NBR having a low glass transition temperature is very poor, and thus NBR should not be applied to engine driving parts.

Accordingly, the present disclosure is aimed at developing an oil seal rubber composition having heat resistance and oil resistance, which are the same as or higher than those of the related art, and also having freezing resistance.

The oil seal rubber composition according to the present disclosure includes HNBR as a main constituent, and HNBR and NBR will be briefly described below.

NBR is a polymer obtained by copolymerizing butadiene and acrylonitrile. The structure of NBR is represented by the following Chemical Formula 1. Since NBR is obtained by copolymerizing polar monomers (acrylonitrile), oil resistance is excellent.

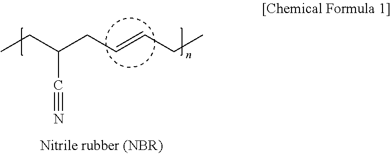

HNBR is a polymer obtained by hydrogenating NBR to saturate a double bond of NBR. The structure of HNBR is represented by the following Chemical Formula 2. HNBR may be polymethylene having a nitrile side chain group. Since HNBR is polymethylene where a main chain is highly saturated, heat resistance is excellent.

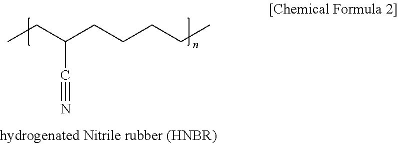

That is, since HNBR includes acrylonitrile, oil resistance is good, and since the main chain is polymethylene, heat resistance is excellent. Thus HNBR is suitable to be used as the oil seal rubber composition.

The oil seal rubber composition according to the present disclosure includes an HNBR including acrylonitrile in the amount of 5 to 20 mole % and having a hydrogen saturation of 80 to 90%.

For reference, in the present disclosure, a definition of the ‘hydrogen saturation’ is as follows. As described above, HNBR is prepared by hydrogenating NBR to saturate the double bond of the main chain. The hydrogen saturation means how much the double bond is removed. That is, a ‘%’ of the hydrogen saturation means a ratio of a repeating unit, in which the double bond is removed, in the entire repeating unit of HNBR.

In the oil seal rubber composition on the market, a content of acrylonitrile is 20 to 45 mole %, and the hydrogen saturation is 90 to 99%. That is, in the oil seal rubber composition according to the present disclosure, as compared to the composition of the related art, the content of acrylonitrile and the hydrogen saturation are low.

Generally, it is known that freezing resistance is improved and heat resistance and oil resistance become poor as the amount of acrylonitrile and the hydrogen saturation of HNBR are decreased.

The present disclosure has technical characteristics in that a balance between freezing resistance, heat resistance and oil resistance is adjusted by optimizing the content of acrylonitrile and the hydrogen saturation of HNBR. When the content of acrylonitrile of HNBR is 5 to 20 mole % and the hydrogen saturation is 80 to 90%, freezing resistance of the oil seal rubber composition including the above content and saturation is sufficiently improved, and thus the glass transition temperature may be reduced to −45° C. or less, and a reduction in heat resistance and oil resistance may not seriously occur.

The present disclosure optimizes conditions to prepare HNBR in order to prevent heat resistance and oil resistance from being reduced.

In a method of preparing the oil seal rubber composition according to the present disclosure, when HNBR (exactly NBR) is prepared, acrylonitrile and butadiene may be agitated at 40 to 60° C. and a rate of 40 to 60 RPM, and then copolymerized.

HNBR in the related art is prepared by agitating acrylonitrile and butadiene at a normal temperature and a rate of 80 to 100 RPM.

In the present disclosure, since monomers are copolymerized by reducing an agitating rate (40 to 60 RPM) at a high temperature (40 to 60° C.) at which the monomers are activated, dispersibility of acrylonitrile is improved, and thus problems of a serious reduction in heat resistance and oil resistance may be solved.

In the method of preparing the oil seal rubber composition according to the present disclosure, when HNBR is prepared by hydrogenating NBR obtained under the aforementioned conditions, hydrogen may be introduced under the presence of a palladium catalyst. Accordingly, since NBR and hydrogen may be easily bonded, problems of a serious reduction in heat resistance and oil resistance may be solved.

The oil seal rubber composition according to the present disclosure may further include, together with HNBR, a filler, a cross-linking agent, a vulcanization accelerator, a cross-linking aid and an age resister.

The filler is used to improve physical properties such as hardness and tensile strength of the oil seal rubber composition. The kinds of the filler are not limited thereto if they can be used for the oil seal rubber composition, but preferably a carbon black may be used.

The carbon black is not limited to a specified product, but preferably, a carbon black FEF (N550) having a particle diameter of 40 to 48 nm may be used.

However, it may be preferable that the carbon black is used in a content of 35 to 45 parts by weight based on 100 parts by weight of HNBR. If the carbon black is included in the content of less than 35 parts by weight, the degree of improvement of the physical properties is low, and if the carbon black is included in the content of more than 45 parts by weight, elasticity may be decreased to reduce sealing performance of the oil seal.

The cross-linking agent is used to form cross-linking between polymer chains when individual constitutions of the oil seal rubber composition are mixed. The types of the cross-linking agent are not limited thereto if they can be used for the oil seal rubber composition, but preferably sulfur may be used.

It may be preferable that the cross-linking agent is used in a content of 1 to 2 parts by weight based on 100 parts by weight of HNBR. When the cross-linking agent is used within the aforementioned numerical range, cross-linking may appropriately occur between individual constitutions, so that the cross-linking agent serves as the oil seal.

The vulcanization accelerator is used to accelerate a vulcanization ability of the cross-linking agent (sulfur) to reduce a vulcanization time. The kinds of the vulcanization accelerator are not limited thereto, if they can be used for the oil seal rubber composition, but preferably N-cyclehexylbenzothiozole-2-sulfenamide (CZ), which is a sulfonamide-based vulcanization accelerator, may be used.

It may be preferable that the vulcanization accelerator is used in a content of 1 to 2 parts by weight based on 100 parts by weight of HNBR. When the vulcanization accelerator is used within the aforementioned numerical range, the vulcanization ability may be effectively accelerated, and the use amount of the cross-linking agent may be reduced.

The cross-linking aid (activating agent) is used to help the cross-linking agent. The kinds of the cross-linking aid are not limited thereto if they can be used for the oil seal rubber composition, but preferably, zinc oxide and a stearic acid may be used alone or used by mixture.

However, it may be preferable that the cross-linking aid is used in a content of 1 to 6 parts by weight based on 100 parts by weight of HNBR. When the cross-linking aid is used within the aforementioned numerical range, the cross-linking aid may effectively help the cross-linking agent to cross-link the individual constitutions of the oil seal rubber composition.

The age resister is used to prevent aging of the rubber (oil seal) due to internal or external factors. The types of the age resister are not limited thereto if they can be used for the oil seal rubber composition, but preferably N-phenyl-N′-isopropyl-p-phenyldiamine (3C) and 2-macratobenzylimide (2-Mcraptobenzimidazole, MB) having excellent heat resistance may be used alone or used by mixture.

It may be preferable that the age resister is used in a content of 1 to 2 parts by weight based on 100 parts by weight of HNBR. When the age resister is used within the aforementioned numerical range, aging of the rubber may be effectively prevented without reducing mechanical properties of the oil seal rubber composition.

Hereinafter, the present disclosure will be described in more detail through the Test Examples. However, the Test Examples are set forth to illustrate the present disclosure, but the scope of the present disclosure is not limited thereto.

### EXAMPLES 1 TO 3 AND COMPARATIVE EXAMPLES 1 TO 4

The oil seal rubber composition satisfying the composition and the content as shown in the following Table 1 was prepared.

TABLE 1

| Component | | Content (parts by weight) |
|---|---|---|
| Raw material rubber | HNBR | 100 |
| Filler | Carbon black FEF¹⁾ | 40 |
| Cross-linking agent | Sulfur | 1 |
| Vulcanization accelerator | CZ²⁾ | 1 |
| Cross-linking aid | ZnO | 5 |
| | Stearic acid | 1 |
| Age resister | MB³⁾ | 1 |
| | 3C⁴⁾ | 1 |

¹⁾Carbon black FEF: N550, particle diameter 40 to 48 nm
²⁾CZ: N-cyclehexylbenzothiozole-2-sulfenamide
³⁾MB: 2-macratobenzylimide(2-Mcraptobenzimidazole)
⁴⁾3C: N-phenyl-N′-isopropyl-p-phenyldiamine

In this case, Examples 1 to 3 and Comparative Examples 1 to 4 were prepared by adjusting the content of acrylonitrile (ACN) of the HNBR and the hydrogen saturation of HNBR as in the following Table 2.

TABLE 2

| | | Comparative | Comparative | Example | Example | Example | Comparative | Comparative |
|---|---|---|---|---|---|---|---|---|
| | | Example 1 | Example 2 | 1 | 2 | 3 | Example 3 | Example 4 |
| HNBR | ACN content | 3 | 8 | 10 | 15 | 20 | 25 | 30 |
| | Hydrogen | 75 | 80 | 85 | 88 | 90 | 95 | 99 |
| | saturation | | | | | | | |

### TEST EXAMPLE

The specimens were prepared by the oil seal rubber compositions of Examples 1 to 3 and Comparative Examples 1 to 4, and hardness, tensile strength, elongation, and heat resistance were measured by the following method.

1. Hardness: based on Section 7 of KS M6518 which is the KS standard

2. Tensile strength: based on Section 5 of KS M6518 which is the KS standard

3. Elongation: based on Section 5 of KS M6518 which is the KS standard

4. Heat resistance: based on Section 8 of KS M6518 which is the KS standard

Furthermore, in order to evaluate freezing resistance of the specimen, the glass transition temperature was measured.

The results are specified in the following Table 3.

TABLE 3

| | | Comparative | Comparative | Example | Example | Example | Comparative | Comparative |
|---|---|---|---|---|---|---|---|---|
| Evaluation item | | Example 1 | Example 2 | 1 | 2 | 3 | Example 3 | Example 4 |
| Hardness [Hs] | | 77 | 76 | 77 | 77 | 77 | 76 | 77 |
| Tensile strength [kgf/cm²] | | 182 | 175 | 195 | 206 | 194 | 185 | 180 |
| Elongation [%] | | 190 | 210 | 220 | 230 | 225 | 205 | 185 |
| Heat | Hardness | +7 | +8 | +6 | +4 | +5 | +5 | +6 |
| resistance | change | | | | | | | |
| (135° C. × | [Hs] | | | | | | | |
| 70 hrs) | Tensile | −11 | −9 | −7 | −5 | −2 | −5 | −4 |
| | strength | | | | | | | |
| | change | | | | | | | |
| | ratio [%] | | | | | | | |
| | Elongation | −10 | −11 | −8 | −3 | −6 | −3 | −3 |
| | change | | | | | | | |
| | ratio [%] | | | | | | | |

| | | | | | | | |
|---|---|---|---|---|---|---|---|
| Glass transition | −32 | −33 | −45 | −47 | −46 | −34 | −29 |
| temperature (° C.) | | | | | | | |

The oil seal rubber composition of the related art, which has freezing resistance and has been on the market, is obtained by mainly adding the plasticizer to HNBR, and has hardness of about 75 Hs, tensile strength of about 200 kgf/cm², and elongation of about 240%. Furthermore, it is known that a hardness change which is an index of heat resistance is about +5, a tensile strength change ratio is about +5%, and an elongation change ratio is about −7%.

Referring to Table 3, it can be seen that physical properties and heat resistance of the oil seal rubber composition (Examples 1 to 3) according to the present disclosure are the same as or higher than those of the rubber composition of the related art.

In light of the oil seal rubber composition having freezing resistance in the related art, in which a TR-10 value (10% elasticity restoring temperature, which is treated to be the same as the glass transition temperature) is at a level of about −30 to −35° C., it can be seen that the glass transition temperature of the oil seal rubber composition according to the present disclosure is −45 to −47° C.

That is, the present disclosure is the oil seal rubber composition including HNBR where the content of acrylonitrile is 5 to 20 mole % and the hydrogen saturation is 80 to 90%, and has a technical characteristic in that the glass transition temperature is reduced to −45° C. or less without a reduction in physical properties and heat resistance.

Particularly, it can be seen that when the content of acrylonitrile is 15 mole % and the hydrogen saturation is 88%, physical properties, heat resistance, and freezing resistance (glass transition temperature) are optimal.

Therefore, there is a merit in that if the oil seal to which the oil seal rubber composition according to the present disclosure is used, problems related to freezing resistance may be solved since a sealing function thereof is maintained in a cold area.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

What is claimed is:

1. An oil seal rubber composition having improved freezing resistance, comprising:
a hydrogenated nitrile butadiene rubber (HNBR) including acrylonitrile in a content of 5 to 20 mole %,
wherein a hydrogen saturation of the HNBR is 80 to 90%.

2. The oil seal rubber composition of claim 1, wherein the HNBR includes acrylonitrile in a content of 15 mole % and includes a hydrogen saturation of 88%.

3. The oil seal rubber composition of claim 1, further comprising:
35 to 45 parts by weight of a carbon black based on 100 parts by weight of the HNBR.

4. The oil seal rubber composition of claim 1, further comprising:
based on 100 parts by weight of the HNBR,
1 to 2 parts by weight of sulfur; and
1 to 2 parts by weight of N-cyclehexylbenzothiozole-2-sulfenamide (CZ).

5. The oil seal rubber composition of claim 1, further comprising:
1 to 6 parts by weight of one or more selected from the group consisting of zinc oxide and a stearic acid based on 100 parts by weight of the HNBR.

6. The oil seal rubber composition of claim 1, further comprising:
1 to 2 parts by weight of one or more selected from the group consisting of N-phenyl-N′-isopropyl-p-phenyldiamine (3C) and 2-macratobenzylimide (2-mcraptobenzimidazole, MB) based on 100 parts by weight of the HNBR.

7. A method of preparing an oil seal rubber composition having improved freezing resistance, comprising:
mixing 100 parts by weight of a hydrogenated nitrile butadiene rubber (HNBR) including acrylonitrile in a content of 5 to 20 mole % and having a hydrogen saturation of 80 to 90%, 35 to 45 parts by weight of a carbon black, 1 to 2 parts by weight of sulfur, 1 to 2 parts by weight of N-cyclehexylbenzothiozole-2-sulfenamide (CZ), 1 to 6 parts by weight of one or more selected from the group consisting of zinc oxide and a stearic acid, and 1 to 2 parts by weight of one or more selected from the group consisting of N-phenyl-N′-isopropyl-p-phenyldiamine (3C) and 2-macratobenzylimide (2-mcraptobenzimidazole, MB).

8. The method of claim 7, wherein the HNBR is obtained by agitating and copolymerizing acrylonitrile and butadiene at 40 to 60° C. and at a rate of 40 to 60 RPM.

9. The method of claim 7, wherein the HNBR is prepared by hydrogenating a nitrile butadiene rubber (NBR) in the presence of a palladium catalyst.
